(19) United States
(12) Patent Application Publication
(10) Pub. No.: US 2008/0084192 A1
(43) Pub. Date: Apr. 10, 2008

(54) Method For Amplifying Energy Temperature-Sensitive Fluid And Converting It Into Power Generating Energy

(76) Inventors: Buhei Kono, Kyoto (JP); Kazuhito Kono, Kyoto (JP)

Correspondence Address: Buhei Kono, 801 Tawdcityhoues 313 Sashimonocho Ebisogwadori, Agara Kawaromachidori, Nakagyo-ku, Kyoto-shi, 604093, omitted

(21) Appl. No.: 11/632,467

(22) PCT Filed: Jul. 19, 2005
(86) PCT No.: PCT/JP05/13983

§ 371 Date: Jan. 16, 2007

(30) Foreign Application Priority Data
Jul. 23, 2004 (JP) 2004-240161

(51) Int. Cl. H02K 44/08

(52) U.S. Cl. 322/2 R

(57) ABSTRACT

Into a temperature-sensutive magnetic fluid in a mixture layer state, 0.01-5 vol % of argon gas based on the volume of the structure of the temperature-senstive magnetic fluid is injected, and the mixture is irradiated with microwave or high frequency millimeter wave and placed in an external magnetic field by means of a permanent magnet or superconducting electromagnet. The argon gas is ionized to generate plasma seeds, and an electric field is formed in the temperature sensitive magnetic fluid, they react with the magnetic field of the temperature-sensitive magnetic fluid, thus amplifying the energy of the temperature-sensitive magnetic fluid. A piece of noble metal such as gold, silver, platinum or rhodium or microparticles of a noble metal are inserted into temperature-sensitive magnetic fluid in a mixture layer state. When the noble metal is irradiated with microwave, plasmon oscillation takes place to enhance the electric field. The energy of temperature sensitive magnetic fluid is enhanced through the interaction of the electric field and magnetic field of the temperature-sensitive magnetic fluid. In proportion to the electric field of amplified energy of the temperature sensitive magnetic fluid, a Lorentz electromagnetic force is generated and utilizes the power of generation energy.

### BACKGROUND OF INVENTION

This invention relates to the energy transformation system of thermomagnetic fluid and the electric generator use of thermomagnetic fluid.

The method used in this invention is the following: heating mixed phase of thermomagnetic fluid which has different magnetization rate depending on temperature by microwave, milliwave, or high frequency wave and cooling by mixing with water. By applying a magnetic field from the outside, the energy of the thermomagnetic fluid becomes electric generating power. By adding rare gas and precious metal to the thermomagnetic fluid, heating with microwave, milliwave and high frequency wave, and applying plasma oscillation and drift movement the energy of the thermomagnetic fluid is amplified.

### SUMMARY OF THE INVENTION

This invention is the method of placing precious metal, Pt, Au, Ag, Pt—Rh plate or particles in thermomagnetic fluid, pouring Ar gas into it, irradiating with microwave, milliwave, or high frequency wave, and applying a magnetic field by a permanent magnet or superconducting magnet. The energy of the thermomagnetic fluid is also amplified by the lorentzian force of the electromagnetic fluid.

This invention is following: we pour Ar gas which is from 0.01% to 5% of the volume of the fluid into two or more kinds of mixed phase thermomagnetic fluid. We apply a magnetic field from the outside, induce microwave, milliwave and high frequency wave from a magnetron, and apply a magnetic field to the thermomagnetic fluid and Ar gas. The electrons and ions are seperated and ionized. The ionized Ar gas forms plasma seeds in the mixed thermomagnetic fluid. That forms a mixed phase. An electric field is formed in the thermomagnetic fluid, and becomes electromagnetic fluid. The thermomagnetic fluid gets electro-fluid. The force by that electric-fluid (f) is written by ionized dipole (P) and the electric

field of electro-fluid (E) f=(P ∇)E (1)

f; force, P; dipole by Ar, E; electric field

We heat the thermomagnetic fluid by microwave, milliwave, and high frequency wave and cool by water. From this temperature deviation appears in the thermomagnetic fluid. We apply a magnetic field, using permanent magnet and a superconducting magnet. The resulting deviation becomes the propelling power of the thermomagnetic fluid. The electric field of the thermomagnetic fluid is formed by microwave, milliwave and high frequency wave.

By pouring Ar gas into the thermomagnetic fluid, plasma seeds are formed. The electric field is formed and the power f is induced. The deviation of temperature sensitive magnetic flux density and the electric field of plasma seeds of Ar interact when the magnetic field is applied, causing drift movement. The non-linear force of the mixed phase of the thermomagnetic fluid amplifies the energy of the electro-thermomagnetic fluid. For making use of the mechanical energy of the thermomagnetic fluid and turning that to electricity generating power, we set a drum under a fixed axis, and maintain rotational movement. Its continuous rotational energy turns into electricity generating power. The energy of the thermomagnetic fluid remains as a sustainable energy by continuous heating and cooling, and by magnetization change in the thermomagnetic fluid. The magnetization of thermomagnetic fluid decreases at high temperatures. The magnetization increases and recovers as the temperature drops. The heating of the thermomagnetic fluid should be instant.

For heating thermomagnetic fluid, we can make use of microwave, milliwave and high frequency waves. For cooling, we put a drum in a water container. The water from the the water container cools the thermomagnetic fluid. For heating, microwave, milliwave and high frequency waves are induced outside of the drum by a magnetron, through a wave guide. We set up a quartz window and irradiate microwave for heating the thermomagnetic fluid.

To cool the thermomagnetic fluid, we put the drum in the thermomagnetic fluid, and set up a radiator. We circulate water by taking thermomagnetic fluid from the drum, continuously heating and cooling the thermomagnetic fluid. We set a permanent magnet or superconducting magnet outside and along the drum in which the thermomagnetic fluid rotates, and apply a strong magnetic field. We set up a fluid buoyancy drum placing the axis in the container, and making the structure rotate. Inside the fluid buoyancy drum, the permanent magnet, which has the opposite pole of outside of the drum is set at a certain interval. We make a space for the fluid between the permanent magnet, where the thermomagnetic fluid runs. In this space we heat the thermomagnetic fluid by irradiating microwave and milliwave and high frequency wave, and cool thermomagnetic fluid by water from the outside. We introduce Ar gas near the quartz window, close to the area where the strong magnetic field is applied by permanent magnet or superconducting magnet. From the outside of the water container, we introduce Ar gas with a gas cylinder, and set up a place for plasma seeds to form by microwave and milliwave and radio frequency heating.

The structure of the drum is set up to propell the thermomagnetic fluid as effectively as possible. The outer rim or apex of the drum must be central to the propelling force. At the apex and outer rim of drum, some fins are attached to be at the center of the propelling force. The thermomagnetic fluid propells the fins and drum. We make the thermomagnetic fluid by mixing the materials with different Curie point of thermomagnetic fluids and water.

We irradiate Ar gas with microwave, milliwave, and high frequency wave. It is ionized in electrons and ions, forming plasma seeds. The temperature of the thermomagnetic fluid and the total temperature rise up, the deviation of magnetism by temperature disappears, and the efficiency of energy lowers. To prevent energy decreasing, we set up a heat radiator outside the drum set, and put the drum in the water container to cool it.

We set a radiator on the container, and circulate the water in the thermomagnetic fluid. It returns to the axis of drum and causes a temperature deviation. We irradiate microwave, milliwave, and high frequency waves to an Ar gas mixture in the thermomagnetic fluid. Ar gas is ionized into electrons and ions, and plasma seeds are created. The electric field of the plasma seeds and the magnetic field of the thermomagnetic fluid interact with each other. The thermomagnetic fluid converts to fluid mechanical energy along with the direction of the magnetic field applied outside by a permanent magnet or superconducting magnet. The thermomagnetic fluid has conductivity because of the plasma seeds and becomes an electro-magnetic fluid. Inside the fluid container, the fluid mechanical energy of the thermomagnetic fluid is amplified by the expansion of its volume, the interaction of the magnetic field, and the plasma interaction of plasma seeds and thermomagnetic fluid. This energy propells the drum and becomes rotational energy. We set the drum as the axis to an electric generator and make electricity generating energy.

The electromagnetic fluid has conductivity, and by applying a magnetic field with a permanent magnet and superconductive magnet, the lorentzian electro-motive force occurs. We set up an electro-pole and make electric generating power.

We set precious metal Au, Ag, Pt, PtRh plate and particles in a mixed status of thermomagnetic fluid and irradiate microwave, milliwave and high frequency waves. The microwave, milliwave and high frequency waves and the electrons of the thermomagnetic fluid interact and plasma oscillation occurs. The resonance occurs because the electro-density wave and the electric field of microwave, milliwave and high frequency waves interact. The energy of the electric field is amplified by the resonance. In the thermomagnetic fluid, we set ther precious metal Au, Ag, Pt, Au—Rh, and irradiate with microwave. The precious metal induces plasmon oscillation and the thermomagnetic fluid induces ferrromagnetic resonance. The energy of magnetic field of the thermomagnetic fluid ocsillates and is amplified.

In the thermomagnetic fluid, the energy is greater as the temperature dependent on magnetization is larger. The deviation of magnetic flux density is larger as the temperature deviation of the thermomagnetic fluid is larger. The temperature deviation is gained by continuous cooling and heating. The quick temperature rise of the thermomagnetic fluid is gained by microwave, milliwave, and high frequency wave irradiation. The cooling is gained by water circulation from the outside. From outside the thermomagnetic fluid, we apply a magnetic field by a permanent magnet or superconducting magnet. The thermomagnetic fluid makes fluid motion. The precious metal, Au, Ag, Pt, Pt—Rh exist in the thermomagnetic fluid. The deviation of magnetic flux density, the plasmon oscillation of precious metals and the ferromagnetic resonance of thermomagnetic fluid amplify the fluid energy.

In the experiment, the thermomagnetic fluid that uses Mn—Zn ferrite has a magnetic field that oscillates at 50 gauss/sec, amplifying the energy of thermomagnetic fluid. The amplification of this energy is stated in the following thermomagnetic fluid energy equation.

$$\begin{matrix}P = T ( \frac{\partial M}{\partial T} ) \frac{DH}{Dt} & ( 2 ) \\ \frac{DH}{Dt} = \frac{\partial H}{\partial t} + {v}_{H} \frac{\partial H}{\partial x} & ( 3 ) \\ P = T ( \frac{\partial M}{\partial T} ) \frac{\partial H}{\partial t} + T ( \frac{\partial M}{\partial T} ) {v}_{H} \frac{\partial H}{\partial x} & ( 4 )\end{matrix}$$

P; energy, T; temperature, M; magnetization, H, the magnetic field of magnetic fluid, v_{H}; velocity of magnetic fluid, x; the distance of magnetic fluid From equation (2), the energy of the thermomagnetic fluid P is a multiple of temperature T, magnetization per temperature ∂M/∂T, and the derivative of the magnetic field of the thermomagnetic fluid DH/Dt. The derivative of the magnetic field of thermomagnetic fluid is written in equation (3). This term is written as the magnetization change per time ∂H/∂t, and the multiple of the velocity of thermomagnetic fluid and the change of magnetic field by distance v_{H}∂H/∂x. As a result, the energy P from equation (2) is the term of the multiple of temperature, magnetization per temperature, and magnetic field change by time is T (∂M/∂T) (∂H/∂t), plus the multiple of temperature, magnetization per temperature, velocity of thermomagnetic fluid and magnetic field change of thermomagnetic fluid by distance T (∂M/∂T) v_{H}(∂H/∂x).

As the result of term T (∂M/∂T) ∂H/∂t. below Curie temperature, the energy of thermomagnetic fluid is larger as the temperature is larger, and the change of magnetization per temperature is larger. We heat the thermomagnetic fluid by microwave and cool the thermomagnetic fluid by water from the outside. The energy is larger as the change of the magnetic flux density by time is larger. When we irradiate microwave Mn—Zn ferrite with the precious metal, the magnetic field by time oscillates ∂H/∂t=50 gauss/sec. The energy is amplified by the interaction of plasma oscillation and the thermomagnetic fluid.

As a result of the term T (∂M/∂T) v_{H}∂H/∂x, the energy of the thermomagnetic fluid is larger as the temperature is larger under the Curie point. The energy of the thermomagnetic fluid is larger as the magnetization change per temperature is larger, and the multiple of the magnetic field change by distance and Velocity is larger. The energy of the thermomagnetic fluid is proportional to the magnetic field applied from outside by a permanent magnet or superconducting magnet.

The electric field amplified by plasmon oscillation and the oscillation of the magnetic field of the thermomagnetic fluid interact and amplify the fluid energy of the thermomagnetic fluid as electromagnetic fluid. When we apply a magnetic field by a permanent magnet or superconducting magnet, the Lorentzian electro-motive force is induced. The thermoelectricity is induced by the mixed status of particles of the precious metal and the thermomagnetic fluid.

We add the precious metal Au, Pt, Pt—Rh, Ag, as a plate, bar, or particles to the thermomagnetic fluid, and irradiate microwave, milliwave and high frequency wave to amplify the energy. In order for the mechanical energy of thermomagnetic fluid to amplify electric energy, we add particles of the precious metal to the fluid and place a bar of precious metal nearby a portion of the thermomagnetic fluid. The plasmon oscillation is influenced by the magnetic field. The bar of precious metal is placed between the portion that we irradiate microwave and the portion to which strong magnetic field is applied by a permanent magnet or superconducting magnet. The electric field created by plasmon oscillation of precious metal amplifies the magnetic field. We irradiate microwave, high frequency wave and milliwave to the precious metal bar and particles.

Plasmon oscillation amplifies the energy and the thermomagnetic fluid becomes a conducting electromagnetic fluid. We apply the magnetic field to the conducting electro-magnetic fluid from the outside by a permanent magnet or superconducting magnet, and lorentzian electro-motive force is induced.

In the mixed status of the magnetic fluid and precious metal, temperature deviation and thermoelectricity is induced. The lorentzian force and thermoelectricity generate the electric power.

We pour Ar gas 0.01% to 5% of the volume of the thermomagnetic fluid. Simultaneously we place a bar, plate and particles of precious metal Au, Pt, Ag, Pt—Rh in thermomagnetic fluid. We irradiate microwave, milliwave and high frequency waves by adding a strong magnetic field by a permanent magnet and superconducting magnet. Plasma seeds of ionized Ar gas and mixed status of thermomagnetic fluid lead to non-linear amplification of energy and the amplification of electric field of plasmon oscillation of Au, Ag, Pt, Pt—Rh. The energy transportation of plasmon oscillation of thermomagnetic fluid and oscillation of magnetic field of ferromagnetic resonance of microwave in the thermomagnetic fluid, interact with each other and amplify the electric field, magnetic field, and the energy of the thermomagnetic fluid.

The equation of energy is the following equation

$$P = {\int }_{ }^{ } \frac{{I}^{2}}{2 {L}^{2}} {( 1 + {ϰ}_{m} )}^{2} d v + \frac{{A}^{2}}{2 {L}^{2}} {}_{}^{2}{( 1 + {ϰ}_{m} )}{}_{}^{2} {\int }_{ }^{ } {( \frac{d H}{d t} )}^{2} d v + \frac{{A}^{2}}{2 {L}^{2}} {}_{}^{2}{( 1 + {ϰ}_{m} )}{}_{}^{2} {( 1 + {ϰ}_{e} )}^{2} {\int }_{ }^{ } {( \frac{d E}{d t} )}^{2} d v \qquad ( 5 )$$

P; energy, I; electric current in thermomagnetic fluid, L; the distance of thermomagnetic fluid, μ; permeability, χₘ; magnetic susceptibility, A; cross section of thermomagnetic fluid, ε; permittivity, H; magnetic flux density t; time, χₑ; electric susceptibility, E; electric field

From the equation (5), the first term of the energy of interaction between electric field and magnetic field is proportional to the square of the current of the volume of magnetic fluid, and proportional to the inverse square of the distance of the thermomagnetic fluid. The energy is larger as the permeability and magnetic susceptibility is larger. From the equation (5), the second term of energy is proportional to the square of the change of the magnetic field per time, proportional to the square of a cross section of thermomagnetic fluid and the inverse square of the distance of the thermomagnetic fluid. The energy is larger as the permeability, magnetic susceptibility, and permittivity are larger. From equation (5) the third term of the energy of the thermomagnetic fluid is proportional to the square of the change of the electric field per time, proportional to the square of a cross section of thermomagnetic fluid, and the inverse square of the distance of the thermomagnetic fluid. The energy is larger as permeability, magnetic susceptibility, permittivity and electric susceptibility is larger. We pour Ar gas 0.01%˜5% of the volume of thermomagnetic fluid, and apply magnetic field and irradiate microwave, milliwave and high frequency waves. The Ar gas is polarized to ions and electrons. The amplification of energy at this time is proportional to the square of the change of the electric field per time. As a result, the thermomagnetic fluid forms a large electric field by the plasma seeds of Ar gas and becomes a conductive, electro-fluid. The equation of the drift movement of the conducting thermomagnetic fluid interacting with the magnetic field is the following.

f=ρ E+j×H+(P ∇)E+(M ∇)H (6)

f; the force of drift movement, ρ; charge density, E; electric field, j; electric current, P; polarization, M; magnetization, H; magnetic field,

j×H is the term where we pour Ar into the thermomagnetic fluid, and apply magnetic field from outside, ionizing the ions and electrons, and inducing the lorentzian force of the conducting electro-magnetic fluid. P is the polarization of ions and electrons, E; electric field, P (∇) E is the term where Ar gas plasma seeds create electro-magnetic fluid that induces polarization of ions and electrons. M is the magnetization and (M ∇) H is the term of the magnetic field of the thermomagnetic fluid. The plasmon oscillation of Au, Ag, Pt, Pt—Rh ampilifies electric field E. We irradiate microwave, milliwave and high frequency waves to the thermomagnetic fluid, the ferromagnetic resonance occurs and amplifies the magnetic field H. The polarization P by Ar gas is larger as the energy is larger. As plasma seeds created by Ar, and Au, Ag, Pt—Rh plasmon oscillation increases, the energy increases. The magnetic field H and magnetizaiton M are larger, the energy is larger. From equation (2), (3), (4) and (6), we pour Ar gas 0.01% to 5% of the volume of mixed status of thermomagnetic fluid, and irradiate microwave, milliwave and high frequency wave. The Ar gas is ionized, forming a large electric field, and creating much energy. We irradiate microwave, milliwave and high frequency wave to a precious metal bar and particles induces plasmon oscillation and therefore amplifying the electric field. We irradiate microwave, milliwave and high frequency wave to thermomagnetic fluid. The magnetism change per temperature is induced and creates magnetic energy. The energy created by the ferromagnetic resonance of the thermomagnetic fluid that is induced by irradiating microwave, milliwave and high frequency wave to thermomagnetic fluid by applying a magnetic field, is expressed in the following equation.

$$P = {\int }_{ }^{ } ( J \times H ) d L + \frac{1}{2} {E}^{2} + T ( \frac{\partial M}{\partial T} ) \frac{DH}{Dt} \qquad ( 7 )$$

P; the energy of thermomagnetic fluid, J; current in thermomagnetic fluid, H; magnetic field of thermomagnetic fluid, L; the distance of thermomagnetic fluid, α; atomic polarizability of Ar gas, E; electric field, M; magnetization of thermomagnetic fluid, T; temperature, t; time

In this equation (7) the first term of the integral is the lorentzian electro-motive force in the length L of the thermomagnetic fluid. The lorentzian electro-motive force is larger as the currency of the thermomagnetic fluid by plasmon oscillation of precious metal Ag, Au, Pt, Pt—Rh and plasma seeds of Ar, and magnetic field H are larger.

The second term of equation (7) is the total of the electric field, that is the square of the electric field that is created by plasma seeds of Ar gas plasmon oscillation of precious metal of Ag, Au, Pt, Pt—Rh irradiated by microwave, milliwave and high frequency wave, and polarizability of Ar gas. The last term in equation (7) is the heating of the thermomagnetic fluid by microwave and milliwave and high frequency wave and the cooling by water, magnetization change by temperature, plasma oscillation of Ar, and precious metals, Au, Ag, Pt, Pt—Rh interacting with magnetic field. The magnetization change by distance that is applied to the magnetic field from the outside by a permanent magnet or superconducting magnet. The energy is proportional to temperature under curie point. The thermoelectricity is induced by the particles of precious metals by temperature change. We pour Ar gas and place the precious metal in the thermomagnetic fluid, heat by microwave, milliwave and high frequency wave and cool by water, apply a magnetic field by superconducting magnet or permanent magnet, and make an electric generator. The place where we set the precious metal is near the portion of magnetic field applied from outside by permanent magnet or superconducting magnet and the portion irradiaited by microwave, milliwave, and the portion where we pour Ar. The bar is an electrorode and induces lorentzian motive force. The bar of precious metal is set at the place influenced by permanent magnet or superconducting magnet and irradiated by microwave, milliwave and high frequency wave.

### DESCRIPTION OF INVENTION AND PREFERRED EMBODIMENT

For taking advantage of the mechanical energy of the thermomagnetic fluid and making its energy turn to electric generating power, we fix the buoyancy body and make it rotate, connecting the energy of rotation to an electricity generating machine. In the water container, we set the buoyancy body under the axis of rotation and make it rotate.

In order to keep the thermomagnetic fluid energy continuously rotating, we continuously heat and cool the thermomagnetic fluid. The magnetization changes continuously. For heating thermomagnetic fluid we use microwave, milliwave and high frequency waves from a magnetrron which we induce through a wave guide, and irradiate through a window of quartz glass.

For cooling we pour water into the container holding the thermomagnetic fluid and the rotaional drum. To raise the efficiency of cooling, we set the radiator in water container, and circulate with a cooling tube to return the water to the center of the water container. We circulate the thermomagnetic fluid, and circulating drives the fluid buoyancy body. We heat and cool interchangeably. We set up a radiator plate for radiating domestic heat to the water container. To keep the water container under a stable temperature, we circulate water from the outside.

To apply a magnetic field from outside we set a permanent magnet or superconducting magnet on the outer rim of the drum in which the thermomagnetic fluid flows. In the domestic of the water container, we set the permanent magnet on the drum rotating under a fixed axis interacting with the magnetic field.

The outer rim and fluid buoyancy drum are set at some interval. In that space, we irradiate microwave, and milliwave, and high frequency waves to the thermomagnetic fluid for heating, and cooling from outside the drum by water. The energy of the mixed state of the thermomagnetic fluid with water interacts with the drum most efficiently in the structure in which the energy is concentrated in outer rim, and rotated. The structure of the drum for interacting with the energy of the thermomagnetic fluid is that the fins are set on the appex and are pressurized by the thermomagnetic fluid, causing the drum to rotate, lower temperature thermomagnetic fluid goes to the drum, and flows to the apex of the drum. Therefore we make the temperature deviation and stable flow of the thermomagnetic fluid.

The temperature sensitive magnetic material Fe₃O₄, Ni—Zn ferrite, Mn—Zn ferrite, Ba ferrite, Sr ferrite, are mixed in magnetic fluid ratio of 1:1. We irradiate by microwave and heat them. The energy of the magnetic fluid is amplified by non-linear force of the thermomagnetic fluid. In the thermomagnetic fluid 1:1 mixed status described previously, we put water 1:1:1 in the mixed status of thermomagnetic fluid. Not only by non-linear force also but by volume expansion the energy of thermomagnetic fluid is amplified.

In the mixed status of thermomagnetic fluid and water described previously, we put 0.01%˜5% Ar gas and apply strong magnetic field by permanent magnet or superconducting magnet, we irradiate microwave, Ar gas is ionised and form plasma seeds and amplifies the energy of thermomagnetic fluid.

In the mixed status of thermomagnetic fluid and water described before, we put the the bar, plate and particles of Au, Pt, Pt—Rh, Ag. We irradiate microwave and heat and apply a strong magnetic field from the outside by permanent magnet or superconducting magnet. The precious metal induces plasmon oscillation, and the energy of thermomagnetic fluid is amplified.

In the thermomagnetic fluid previously described, we place precious metal and Ar gas. The plasma seeds of Ar gas and the plasmon oscillation of precious metal amplifies the electric field, interacts with the magnetic field and amplifies the energy of thermomagnetic fluid.

In the wave guide of microwave, length and height 10.4 cm each that is induced from magnetron, we make a hole with a radius of 0.6 cm, and we set a helical quartz tube of length 8 cm, radius 0.5 cm crossing the wave guide. Nearby the wave guide Which contains quartz glass, we set the permanent magnet of 0.3 T. In the quartz tube we place mixed status thermomagnetic fluid of Fe₃O₄, and Mn—Zn ferrite, ratio 1:1. We irradiate microwave to the thermomagnetic fluid raising the temperature for 40 seconds. The fluid motion of the thermomagnetic fluid is observed. The velocity of fluid is 2.5 m/s.

In this set up, previously mentioned, we pour water into the thermomagnetic fluid ratio 1:1:1 and irradiate microwave, raising temperature for 40 seconds, doubling or tripling the velocity to 7 m/s. In this set up, as previously mentioned, we pour into the thermomagnetic fluid the Ar gas. We irradiate microwave and Ar gas is ionized, forming plasma seeds, and the temperature of the thermomagnetic fluid rises up in 10 seconds. The energy of the thermomagnetic fluid is amplified, and the velocity of the fluid increases 4 or 5 times to 35 m/second.

In the set up, as previously mentioned, we set up particles of the thermomagnetic fluid 10 μm and bar Au, Pt, Ag, Pt—Rh 0.1% in volume weight, and a permnent magnet 0.3 T. We irradiate microwave. After 40 seconds, the precious metal induces plasmon oscillation and in 4 seconds, the temperature oscillates within 100° C. The energy of the thermomagnetic fluid is amplified 4 or 5 times and the velocity of the fluid is 35 m/s.

In the set up, previously mentioned, of mixed status thermomagnetic fluid, we pour Ar gas and precious metal Au, Pt, Ag, Pt—Rh. By the interaction with plasma seeds of Ar gas and plasmon oscillation of precious metal, the electric field is amplified, and the electric field interacts with the magnetic field of the thermomagnetic fluid. The temperature of the thermomagnetic fluid rises up to 100° C. in 4 seconds. The energy is amplified 9 or 10 times, and the velocity of the fluid is 70 m/seconds.

What is claimed is:

1. The method of energy amplification system comprising the steps of;
the thermomagnetic fluid wherein the deviation of magnetic flux density by temperature of said thermomagnetic fluid propells fluid energy;
the water for cooling is poured in said thermomagnetic fluid and microwave milliwave and high frequency waves are irradiated to said thermomagnetic fluid for heating;
Ar gas being poured into said thermomagnetic fluid and ionized into the ion and electron by irradiating said microwave, milliwave, high frequency waves in said thermomagnetic fluid reaching higher temperature than normal thermomagnetic fluid;
the permanent magnet or superconducting magnet whereby applying strong magnetic field to said themomagnetic fluid and Ar gas induces deviation of temperature dependent magnetic flux density of said thermomagnetic fluid and induces the ionization of Ar gas;
the lorentzian electromotive force is induced said thermomagnetic fluid by ionized gas and electron;
Ionized gas and electron inducing the deviation of the electric field, forms plasma seeds and the deviation of magnetic flux density in said thermomagnetic fluid by water cooling and microwave heating forms high energic thermomagnetic fluid.

2. The electric generator made by placing a rotational drum with fins in said thermomagnetic fluid as recited in claims 1 whereby taking advantage of the energy amplification system recited in claim 1.

3. The method of energy amplification system comprising the steps of inserting precious metals in recited claim 1 in said thermomagnetic fluid;
the precious metals, Pt, Au, Ag, Au—Rh bar, plate and particles inserted into said thermomagnetic fluid that irraidiated by microwave, milliwave, high frequency wave system and having been magnetized by applying strong magnetic field by said permanent magnet or superconducting magnet, induce plasmon oscillation in rare metal, interacting with electromagnetic wave and density waves in rare metal, forming the resonanced state and amplifies the energy of said thermomagnetic fluid;
the ferromagnetic resonance is induced in said thermomagnetic fluid by irradiating microwave, milliwave and high frequency wave with applying strong magnetic field by permanent magnet and superconductive magnet and induces the amplification of the energy of said thermomagnetic fluid.

4. The electric generator made by placing a rotational drum with fins in said thermomagnetic fluid as recited in claims 3 whereby taking advantage of the energy amplification system recited in claim 3.

5. The energy amplification system comprising the steps of concurrent use of claim 1 and claim 3 wherein;
the electric field of ionized Ar gas present in the thermomagnetic fluid having been magnetized by applying strong magnetic field using permanent magnet or superconducting magnet interacts with the magnetic field of said thermomagnetic fluid and amplifies the energy of thermomagnetic fluid;
the energy in said thermomagnetic fluid is amplified by ferromagnetic resonance by irradiating microwave, milliwave and high frequency waves to said thermomagnetic fluid with applying strong magnetic field by permanent magnets and superconductive magnet;
the electric field of rare metals, Pt, Au, Ag, Au—Rh, amplified by said plasmon oscillation induced by strong magnetic field using permanent magnet or superconducting magnet interacting with the magnetic field of thermomagnetic fluid and amplifies the energy of thermomagnetic fluid;
the Lorentzian force induced by the magnetic field of thermomagnetic fluid, the electric field of ionized Ar gas and the plasmon oscillation of rare metals amplify the energy of the thermomagnetic fluid.

6. The electric generator made by placing a rotational drum with fins in said thermomagnetic fluid as recited in claim 5 whereby taking advantage of the energy amplification system recited in claim 5.
